(19) United States
(12) Patent Application Publication
(10) Pub. No.: US 2006/0165145 A1
(43) Pub. Date: Jul. 27, 2006

(54) Diode-pumped ~812 nm thulium-doped solid state laser

(76) Inventor: William F. Krupke, Pleasanton, CA (US)

Correspondence Address: John P. Woolridge, Esq., 114 Honu'ea Pl., Kihei, HI, 96753, US

(21) Appl. No.: 11/335,065

(22) Filed: Jan. 18, 2006

Related U.S. Application Data
(60) Provisional application No. 60/646,451, filed on Jan. 25, 2005.

(51) Int. Cl. H01S 3/091; H01S 3/10; H01S 3/11; H01S 3/098

(52) U.S. Cl. 372/70; 372/22; 372/18; 372/10

(57) ABSTRACT

A diode-end-pumped ˜812 nm thulium doped solid state laser is disclosed, with improved efficiency and practicality. The inventive laser device include laser active media comprising a thulium doped dielectric solid state gain element, placed within a laser cavity, and diode-end-pumped with ˜780 nm pump radiation. Solid state lasers emitting at a wavelengths of ˜406 nm, ˜270 nm, and ˜203 nm are also disclosed, based on nonlinear wavelength conversion of a ˜812 nm thulium:host solid state laser.

This application claims priority to U.S. Provisional Patent Application Ser. No. 60/646,451, filed Jan. 25, 2005, titled: “Diode-Pumped ˜815 nm Thulium-Doped Solid State Laser,” incorporated herein by reference.

### BACKGROUND OF THE INVENTION

1. Field of the Invention

The present invention relates generally to deep red wavelength lasers and more specifically it relates to a diode-pumped thulium doped solid state laser that produces an output beam having a wavelength of ˜812 nm.

2. Description of the Related Art

During the past few years, solid state lasers emitting at near ultraviolet wavelengths (e.g., ˜400 nm) have found rapidly increasing utility in numerous industrial, commercial, and research applications. Prior art lasers emitting in the 350 nm-400 nm wavelength region are generally of two types: 1) third-harmonic-converted near-infrared solid state lasers; and 2) GaN semiconductor lasers. The first type of laser is typically a flash-lamp- or diode-pumped neodymium doped solid state laser, whose output radiation at a wavelength of ˜1064 nm is frequency tripled to a wavelength of ˜355 nm. This tripling process generally entails 1) generating the second harmonic of the ˜1064 nm fundamental wavelength radiation, and 2) mixing this second harmonic radiation with residual ˜1064 nm fundamental radiation. This cascade nonlinear optical process requires the use of two nonlinear crystals, and adds considerable optical complexity and cost to the ˜355 nm source. The second type of ˜400 nm laser utilizes GaAlN quantum well structures to directly generate radiation in the desired wavelength range, but produces only relatively low output power (<<waft) with near-diffraction-limited beam quality. Thus there is a need to provide more powerful (>>watt), near-diffraction-limited laser sources at the near ultraviolet wavelength of ˜400 nm that are more compact, efficient, and less expensive than the prior art tripled neodymium solid state laser sources, and more powerful than the low power GaN semiconductor laser sources. When using nonlinear processes to generate ˜400 nm ultraviolet radiation, a more ideal approach than frequency-tripling is to use simple, single-step second harmonic generation of a laser source of radiation at a fundamental wavelength of ˜800 nm. At present there are no practical high-power, near-diffraction-limited sold state laser sources emitting in the ˜800 nm spectral region. Mejia et al. [1] and Hanna [2] have described a core-pumped thulium doped fiber laser source emitting at ˜820 nm, but it is impractical to scale this laser to high powers (>>watt) because the demand for diode pump brightness greatly exceeds the brightness of available pump laser diodes.

In addition to improved laser sources at ˜400 nm, there is a growing need for improved laser sources at shorter wavelengths. As the feature size of silicon microelectronic integrated circuits (ICs) continues to decline in the quest for ever-higher speeds (from ˜1000 nm seven years ago to a projected ˜32 nm in the next few years), there continues to be an urgent need for practical laser sources with progressively shorter operating wavelengths for writing photomasks of fine-line patterns for the manufacture of ICs, and for detecting and classifying wafer defects of progressively smaller size, assisting in the cost effective manufacture of ever-higher speed ICs. The laser sources must be scalable in power to sufficient to achieve process throughputs compatible with commercial production economics.

Primarily argon ion lasers have been utilized for fine features defect detection in IC manufacturing. Defects on printed wafers have typically been detected utilizing argon ion lasers emitting 488 nm radiation and those on reticles (masks) have typically been detected utilizing argon lasers whose 514 nm radiation output has been frequency-doubled to 257 nm. While providing adequate power and spectral brightness, argon ion lasers are extremely inefficient (<0.01%), require extensive conditioned electrical power and active cooling, and are physically bulky. The stressing operating conditions within an argon laser generally limit the operating lifetime of a typical argon ion laser tube to <10,000 hours. Thus, there is a need to develop ultraviolet laser sources that are more than an order of magnitude more efficient (i.e., >1%), are much more compact, and require only comparably benign utilities.

In recent years, diode-pumped solid-state lasers have been developed to replace argon ion lasers with performance features that are superior to the argon ion laser. Generally, these lasers comprise a diode-pumped solid-state crystal (such as Nd:YAG or Nd:YVO₄) emitting “fundamental” radiation in the near infrared spectral region (i.e., ˜1064 nm), and one or more harmonic nonlinear optical (NLO) crystal converters. The NLO elements convert the fundamental IR radiation into radiation of shorter “harmonic” wavelengths: 2\overline{ω}, 3\overline{ω}, 4\overline{ω}, etc (i.e., 532 nm, 355 nm, 266 nm, etc.).

Practical laser sources with wavelengths as short as ˜200 nm are now desired to be able to write smaller features in photomasks, and to increase the detectivity of smaller defect features in IC wafers.

It can be appreciated that ˜200 nm ultraviolet lasers have been known for years. These lasers are of several types. The first known such lasers were produced by high-current discharges in various atomic gases, such as argon, neon, and xenon. Generally, ˜200 nm laser transitions take place in the rare gas ions so that these lasers are generally quite inefficient (<<1%), are bulky, and require expensive power conditioning equipment

More recently, laser sources emitting in the ˜200 nm region have been produced using non-linear conversion processes to convert radiation from a “drive’ laser emitting at longer near-infrared wavelengths into the shorter wavelength region. For example, the 5^{th} harmonic of 1064 nm radiation of a Nd:YAG laser produced ˜213 nm radiation. For reasons of obtaining high efficiency with relative simplicity, it is highly desirable to minimize the number of nonlinear conversion processes to attain the desired short operating wavelength. So for example, it would be highly desirable to develop a ˜200 nm laser source based on a fundamental wavelength drive source emitting at ˜800 nm.

The present invention provides a practical solid state laser source of radiation at a wavelength ˜812 nm, employing commercial multi-mode high power pump diodes, enabling the production of just such a more ideal second harmonic source of ˜406 nm radiation. Further, the present invention provides a practical solid state laser sources emitting at ˜812 nm and 406 nm suitable for constructing laser sources at the wavelengths of ˜270 nm and ˜203 nm.

Specifically the present invention teaches efficient generation of ˜812 nm laser radiation from a Tm:host solid state material pumped resonantly in the excited ³H₄ manifold by ˜780 nm laser diodes or diode arrays, and emitting at the wavelength of ˜812 nm in a transition terminating on a high-lying Stark level of the ³H₄ ground state manifold. Radiation at a wavelength of ˜406 nm is produced via harmonic conversion of ˜812 nm radiation of the Tm:host laser. Radiation at a wavelength of ˜270 nm is produced via sum frequency mixing of ˜812 nm and ˜406 nm radiation. Radiation of ˜203 nm wavelength is produced via either second harmonic generation of ˜406 nm radiation or sum frequency mixing of ˜812 nm and ˜270 nm radiation.

The following 11 references are incorporated by reference:

1. E. B. Mejia, L. A. Zenteno, P. Gavrilovic, A. Goyali, “High-efficiency laser at 810 nm in single-mode Tm³⁺doped fluorozirconate fiber pumped at 778 nm”, Opt. Eng. 37, 2699-2702 (1998).

2. D. C. Hanna, J. N. Carter, A. C. Tropper, and R. G. Smart, “Optical Fibre Amplifier and Laser”, U.S. Pat. No. 5,406,410.

3. L. M. Hobrock, L. G. DeShazer, W. F. Krupke, G. A. Keig, D. E. Witter, “Four-level operation of Tm:Cr:YAlO₃ laser at 2.35 microns”, IEEE JQE, 8, 533 (1972).

4. R. C. Stoneman, L. Esterowitz, “Continuous-wave 1.50 μm thulium cascade laser”, Optics Letters, 16, 232-234 (1991).

5. R. J. Beach, E. C. Honea, S. B. Sutton, C. M. Bibeau, J. A. Skidmore, M. A. Emanuel, S. A. Payne, P. V. Avizonis, R. S. Monroe, D. G. Harris, “High-average-power, diode-pumped Yb:YAG lasers”, SPIE, 3889, 246-260 (2000).

6. G. D. Goodno, S. Palese, J. Harkenrider, H. Injeyan, “Yb:YAG power oscillator with high brightness and linear polarization”, Optics Letters, 26, 1672-1674 (2001).

7. R. J. Beach, “CW theory of quasi-three-level, end-pumped laser oscillators”, Opt Communications, 123, 385-389 (1995).

8. B. M. Walsh, N. P. Barnes, M. Petros, J. Yu, U. N. Singh, “Spectroscopy and modeling of solid state lanthanide lasers: application to trivalent Tm³⁺ and Ho³⁺ in YLiF₄ and LuLiF₄”, J. Appl. Phys., 95, 3255-3271 (2004).

9. A. Diening, P. E. Moebert, G. Huber, “diode-pumped continuous-wave, quasi-continuous-wave, and Q-switched laser operation of Yb³⁺, Tm³⁺ in YLiF₄ at 1.5 μm and 2.3 μm”, J. Appl. Phys., 84, 5900-5904 (1998).

10. A. Braud, S. Girard, J. L Doualan, M. Thuau, R. Moncorge, A. M. Tkachuk, “energy-transfer processes in Yb:Tm-doped KY₃F₁₀, YLiF₄, and BaY₂F₈ single crystals for laser operation at 1.5 μm and 2.3 μm”, Phys. Rev., B61, 5280-5292 (2000).

11. A. Brenier, J. Rubin, R. Moncorge, C. Pedrini, “Excited-state dynamics of the Tm³⁺ ions and Tm³⁺—Ho³⁺ energy transfers in YLiF₄”, J. Physique, France, 50, 1463-1482 (1989).

### SUMMARY OF THE INVENTION

It is an object of the present invention to provide a ˜812 nm laser having a thulium doped solid state active medium that is directly (resonantly) optically pumped.

Another object of the present invention is to provide an efficient laser source of ˜406 nm radiation produced by frequency-doubling the ˜812 nm radiation of a thulium:host laser.

Still another object is to provide an efficient laser source of ˜270 nm radiation by sum frequency mixing the ˜812 nm and ˜406 nm radiation of thulium:host based laser sources.

Another object is to provide an efficient laser source of ˜203 nm radiation by fourth harmonic generation of the ˜812 nm radiation of a thulium:host laser.

An object of the present invention is to provide an efficient laser source of ˜203 nm radiation by sum frequency mixing of ˜812 nm and ˜270 nm radiation of thulium:host based laser sources.

Another object is to provide efficient laser sources emitting at wavelengths of ˜812 nm, ˜406 nm, ˜270 nm, and ˜203 nm in continuous-wave, repetitively-pulsed, Q-switched, and mode-locked temporal output waveforms

Other objects and advantages of the present invention will be apparent to those skilled in the art and it is intended that these objects and advantages are within the scope of the present invention.

The present invention generally comprises a laser gain medium formed by selected dielectric crystals doped with trivalent thulium ions, placed within a laser cavity resonant at a wavelength near ˜812 nm, and pumped in one of the stronger ³H₄ absorption transitions at a wavelength of ˜780 nm using an AlGaAs or AlGaAsP based laser diode or diode array. Pump radiation is directed into the laser cavity containing the thulium doped gain crystal element, and is absorbed by the thulium ions. This excitation process induces a population inversion between the ³H₄ upper laser manifold and the ³H₆ terminal laser manifold, causing laser action to occur at ˜812 nm in the ³H₄-³H₆ transition.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 shows the energy levels of the trivalent thulium ion in a dielectric solid and the principal absorption and emission transitions.

FIG. 2 shows a laser configuration for a diode-end-pumped ˜812 nm thulium solid state laser.

FIG. 3 shows an alternate embodiment for a diode-end-pumped ˜812 nm thulium solid state laser.

FIG. 4 shows an embodiment of a diode-end-pumped ˜812 nm thulium solid state laser.

FIG. 5 shows the Tm:YLF ³H₆-³H₄ absorption spectrum in the ˜780 nm spectral (pump) region.

FIG. 6 shows the Tm:YLF ³H₄-³H₆ emission spectrum in the ˜812 nm spectral (laser) region.

FIG. 7 shows Tm:YLF power conversion efficiency at a laser wavelength of ˜812 nm, as a function of pump intensity, with optimized output coupler reflectivity.

FIG. 8 shows an optical configuration of a ˜406 nm frequency-doubled laser utilizing a Tm³⁺:host solid state laser emitting at ˜812 nm as the source of fundamental radiation.

### DETAILED DESCRIPTION OF THE INVENTION

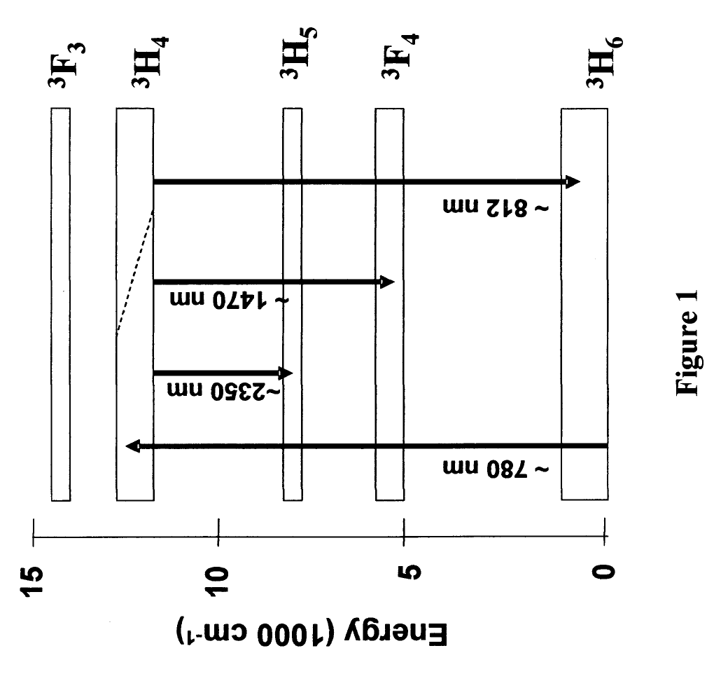

FIG. 1 shows the nominal energy level diagram for the trivalent thulium (Tm³⁺) rare earth ion in a dielectric solid, and the predominant absorption and emission transitions lying below 13,000 cm⁻¹. Generally, when placed in a dielectric solid, the degenerate electronic levels of the free trivalent thulium ion are each split by the local crystal field into a manifold of Stark components. Absorption and emission transitions between the manifolds appear as intensity-modulated narrow bands, each with a mean wavelength characteristic of the dielectric crystal in which the thulium ion is embedded. The ³H₄-³F₄ pump transition absorption wavelengths typically lie between 760 nm and 800 nm, with a mean wavelength of ˜780 nm; the ³H₄-³H₆ laser transition emission wavelengths typically lie between 800 nm and 824 nm, with a mean wavelength of ˜812 nm. In this document, the pump wavelength of the described invention will be designated as ˜780 nm, and the laser wavelength of the described invention will be designated as ˜812 nm, however, specific optimum pump and laser wavelengths will generally lay within the spectral bands cited above, and will depend on the specific dielectric host material being utilized in the laser.

Hobrock [3] reported the observation of laser action at a wavelength of ˜2350 nm using thulium (Tm³⁺) doped yttrium aluminate perovskite single crystal as the laser gain medium. The observed laser action occurred in the ³H₄-³H₅ transition upon flash-lamp excitation of the Tm³⁺ ion absorption levels lying above the metastable ³H₄ manifold, followed by non-radiative relaxation of excitation to the ³H₄ manifold. Given the sparseness of the absorption spectrum of the thulium ion, coupled with the broad spectrum of the pump flash-lamp, the Tm:YAlO₃ laser could be made to oscillate only at cryogenic temperatures, and with an extremely low efficiency. Stoneman [4] reported observation of laser emission at a wavelength of ˜1470 nm using thulium doped yttrium lithium fluoride single crystal as the laser gain medium. The observed laser action occurred in the ³H₄-³F₄ transition upon diode laser pumping of the ³H₄ upper laser manifold at wavelength of ˜780 nm. Thus several examples have been reported in which the ³H₄ manifold serves as the upper manifold of a laser transition. However, laser emission at a wavelength of ˜812 nm, corresponding to the ³H₄-³H₆ transition, has not been observed in dielectric single crystal. This transition terminates on the ground ³H₄ manifold, whose Stark levels contain significant thermal populations of Tm ions (according to a Boltzmann population distribution). Thus, ˜812 nm laser transition in a thulium doped crystal host is necessarily a quasi-three-level laser at room temperature and above, and the host crystal is required to possess certain spectroscopic and population-kinetic properties that enable practical quasi-three-level laser action to occur near ˜812 nm.

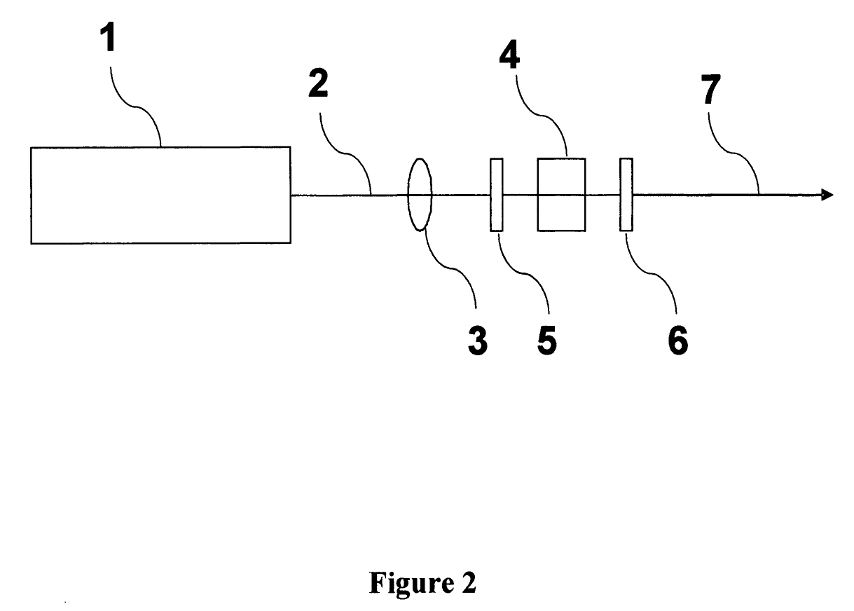

FIG. 2 shows the basic optical configuration of a diode-pumped thulium doped ˜812 nm solid state laser. The diode laser pump source, 1, produces a pump laser beam, 2, at a wavelength matching a relatively strong absorption transition feature of the thulium doped gain medium, 4. Lens, 3, focuses the pump beam, 2, through the laser cavity mirror, 5, into the thulium doped gain element, 4. Mirror 5, is coated with a dielectric stack of thin films that highly transmits the pump radiation, while providing a high reflectivity at the thulium output laser wavelength near ˜812 nm. The second laser cavity mirror, 6, is coated with a dielectric stack of thin films that highly reflects the pump beam for a second pass through the gain element, and also provides a partial reflectivity at the thulium laser output wavelength of ˜812 nm that optimizes the ˜812 nm output power from the thulium laser, as set by the amount of gain produced in the gain element by the pump, and by the amount of losses within the laser cavity at the laser wavelength. The mirror reflectivities at wavelengths of ˜1470 nm and ˜2350 nm should be kept sufficiently low to suppress laser action at these wavelengths in the competing ³H₄-³F₄ and ³H₄-³H₅ transitions, respectively. Alternatively, to suppress laser action at these wavelengths, a filter plate may be inserted between the gain element, 4, and the cavity mirror, 6, having the following properties: high transmission at the ˜780 nm (pump) and ˜812 nm (laser) wavelengths, and high absorption in the ˜1470 nm and ˜2350 nm wavelength regions. The laser output beam, 7, has a wavelength of ˜812 nm. To set and stabilize the precise operating output wavelength (within the gain bandwidth of the ˜812 nm transition), a grating, prism, and/or etalon may be incorporated within the laser cavity, according to principles well-known in the art. The laser configuration of FIG. 2 typically employs as continuous-wave (CW) pump source, 1, and produces a CW ˜812 nm laser output temporal waveform. A repetitively-pulsed temporal laser output waveform may be obtained by repetitively-pulse modulating the pump source, 1. Q-switched and mode-locked temporal laser output waveforms may be obtained using a CW pump source, 1, and incorporating loss-modulating optical elements into the basic laser configuration of FIG. 2, according to principles that are well known in the art

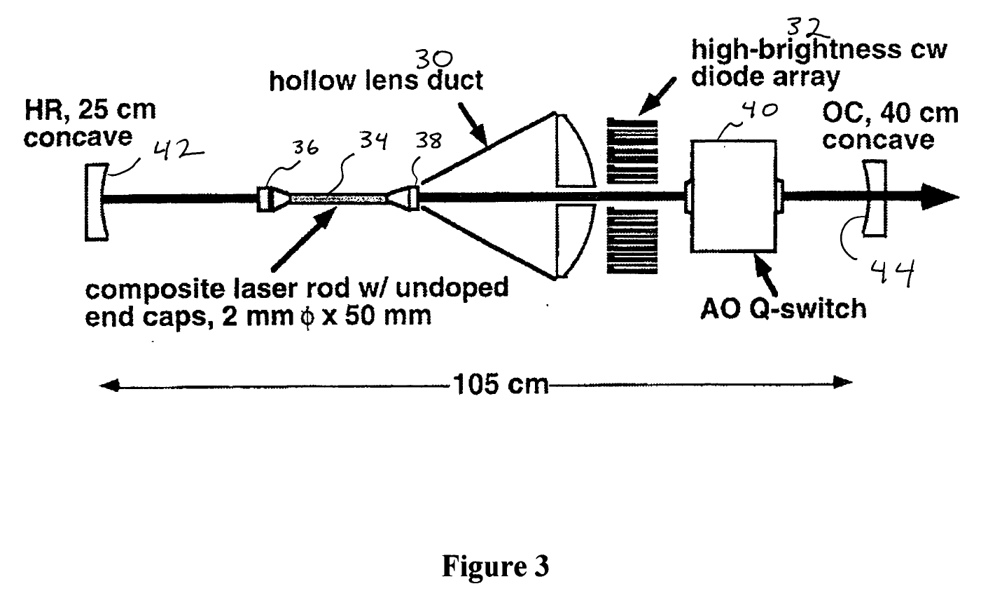

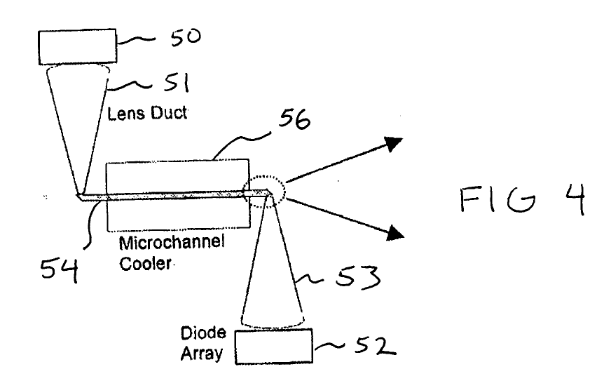

An embodiment [5] that avoids the need to use a dichroic thin-film stack on cavity mirror, 5, is shown in FIG. 3, using a hollow lens duct 30 to deliver pump radiation from a CW diode array 32 to the thulium doped crystal laser rod 34 at a relatively high NA value. The pump radiation is transported down the cylindrical axis of the thulium doped gain element by total internal reflection (TIR). The two ends of the gain element are capped with undoped YLF crystal segments 36, 38 [5] to militate against thermal gradients at the entrance and exit of the gain element This configuration includes an acousto-optic Q-switch 40 and the 105 cm cavity is formed by a 25 cm focal length concave high reflector 42 and a 40 cm focal length concave output coupler 44. Yet another embodiment [6] for pump delivery is shown in FIG. 4. A pump beam from each diode array 50, 52 is directed with a lens duct 51, 53 into the thulium doped gain element 54 at an angle to the symmetry axis of the gain element, by reflecting from the back face of a Brewster's-angel undoped endcap bonded to the end of the gain element. This configuration utilizes a microchannel cooler 56 to cool the gain element

Using the formulation of Beach [7] it is feasible to calculate the quantitative performance of a resonantly pumped thulium doped solid state laser operating in the ³H₄-³H₆ transition near ˜812 nm, provided the necessary spectroscopic data for the thulium doped gain material are known. The required data is completely known [8-11] for the crystal Tm:YLiF₄ (Tm:YLF) and the calculated performance of this laser is presented here for illustration. Other thulium doped crystal hosts can be evaluated for use as practical materials for a ˜812 nm laser if the required spectroscopic and kinetic data are known.

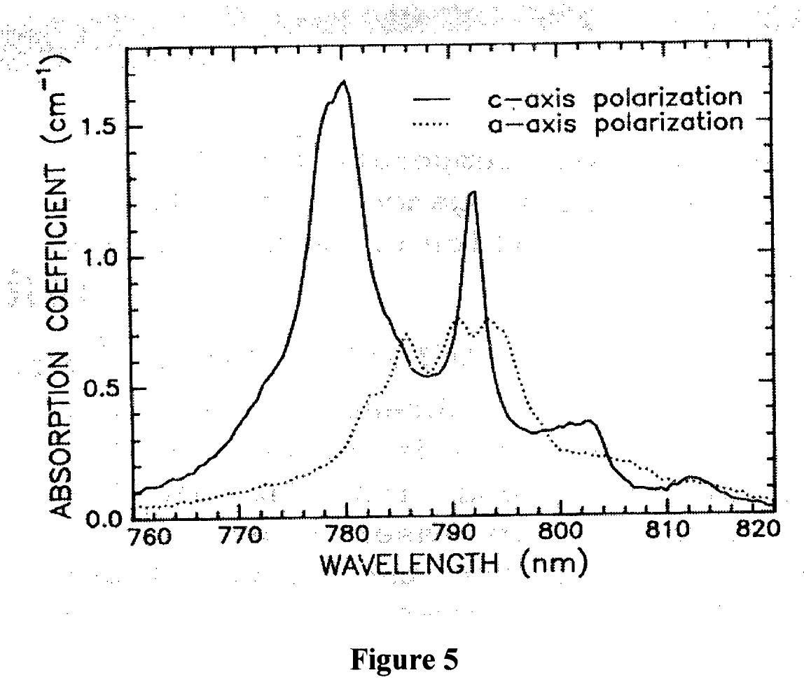

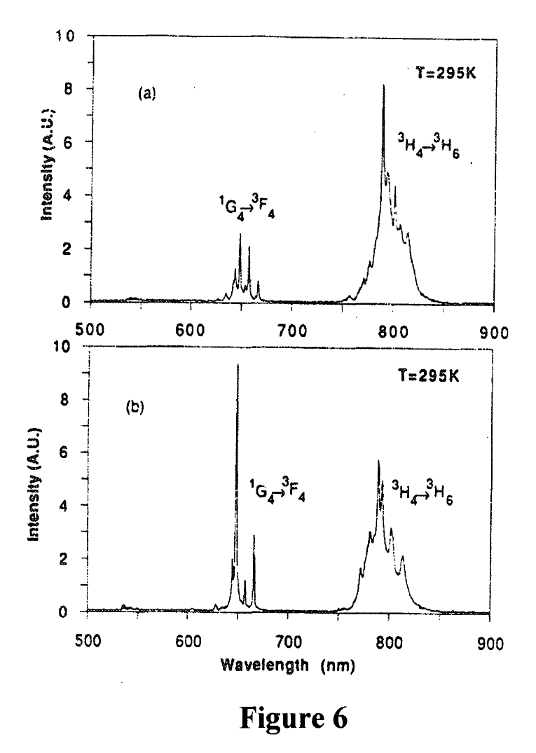

FIG. 5 shows the room temperature, polarized absorption spectrum [8] of YLF doped with 0.5 atomic % Tm³⁺ ions in the ˜780 spectral region of the ³H₆-³H₄ inter-manifold absorption transition. We see that a relatively strong, sigma-polarized absorption feature is present at a wavelength of ˜780 nm, a feature that serves as the pump transition of a ˜812 nm Tm:YLF laser. FIG. 6 shows the room temperature emission spectrum of YLF doped with 0.5 atomic Tm³⁺ ions in the ˜800 nm spectral region. The feature at a wavelength of ˜812 nm terminates on a Stark level of the ground manifold that is ˜450 cm⁻¹ above the ground Stark level of the ³H₆ ground manifold. This emission feature serves as the laser transition of a ˜812 nm Tm:YLF laser.

Table 1 lists the spectroscopic parameters for the Tm:YLF gain crystal. Note that the upper laser manifold ³H₄ has a relatively long radiative lifetime of ˜2 msec. For Tm ion doping levels below ˜0.5 atomic %, the fluorescence lifetime is ˜80% of the radiative lifetime (˜2.5 msec), and the radiative efficiency for emission of photons from the ³H₄ manifold is quite high (˜0.8). This relatively long fluorescence lifetime, and the cross-section for ˜812 nm stimulated emission of 0.4×10⁻²⁰ cm², results in a saturation intensity of ˜32 kW/cm². This saturation intensity is low enough to permit efficient power conversion using commercially-available diode laser pump sources with adequate spatial brightness. Since the laser output wavelength is ˜812 nm, and the pump wavelength is ˜780 nm, the quantum energy defect ratio is 780/815=0.96, This near-unity value, together with the relatively high radiative efficiency of ˜80%, indicates that the ˜812 nm Tm:YLF laser will sustain a relatively low amount if waste heat generation in the laser crystal.

TABLE 1
Key spectroscopic laser parameters for the Tm: YLF crystal [8-12].

| Parameter | Value | Units |
|---|---|---|
| Pump wavelength | 780 | nm |
| Pump transition cross-section | 0.4 × 10⁻²⁰ | cm² |
| Pump saturation flux | 32 | kW/cm² |
| Laser wavelength | 812 | nm |
| Laser transition cross-section | 0.4 × 10⁻²⁰ | cm² |
| Laser saturation flux | 31 | kW/cm² |
| Upper laser level lifetime | 2 | msec |

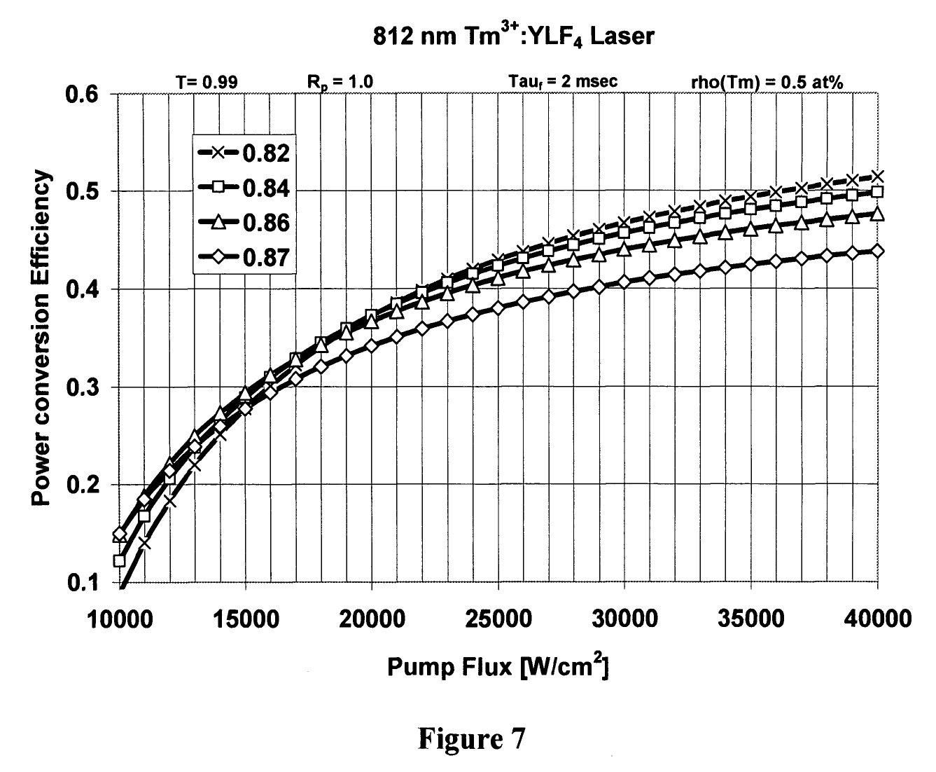

FIG. 7 shows the calculated power conversion efficiency of the Tm:YLF laser using a diode laser pump at ˜780 nm, as a function of pump intensity, with output coupler reflectivity, Rₒₚₜ, as a parameter. The value of Rₒₚₜ shown are values that maximize ˜812 nm output power for various values of n₀*lₛ (the product of Tm³⁺ ion density, n₀, in the YLF crystal and the length of the gain element, lₛ). FIG. 7 shows, for example, that the power conversion efficiency of 40% can be achieved for a pump intensity of 23 kW/cm², averaged over the length of the gain element, with an optimum Rₒₚₜ=0.85. The value of Rₒₚₜ=0.85 corresponds to a value n₀*lₛ=16×10¹⁹ ions/cm² (or about 0.25 atomic % in an 8 cm long crystal), a value for which the ³H₄ manifold is about ˜80% radiative [11]. So, for example, if the pump diode array has a power of 250 watts, the focusing lens is designed to focus the beam to a spot diameter of ˜1 mm at the center of the entrance of the cylindrical gain element, producing a pump intensity there of >23 kW/cm². Under these conditions, the optimum output coupler reflectivity is 85% at ˜812 nm, and the output power at ˜812 nm is 100 Watts. These projected performance values are summarized in Table 2. The projected waste heat characteristics of this laser (density, surface heat flux, center-to-edge temperature difference, etc.) are well within normal waste heat management regime of conventional solid state lasers.

TABLE 2

| Parameter | Value | Units |
|---|---|---|
| YLF rod diameter | 1.12 | mm |
| YLF rod length | 8 | cm |
| Tm ion concentration | 3.5 × 10¹⁹ | ions/cm³ |
| pump power | 250 | W |
| pump spot diameter | 1 | mm |
| pump intensity | >23 | kW/cm² |
| cold cavity single-pass transmission | 0.99 | |
| optimum out-coupler reflectivity | 0.85 | |
| rod averaged laser population | 0.6 × 10¹⁹ | ions/cm² |
| inversion density | | |
| output power | 100 | W |
| output laser intensity | 10.7 | kW/cm² |
| waste heat density | 385 | W/cm³ |
| total waste heat in gain element | 31 | W |
| surface waste heat flux | 11 | W/cm² |
| center-edge temperature difference | 7 | C. |

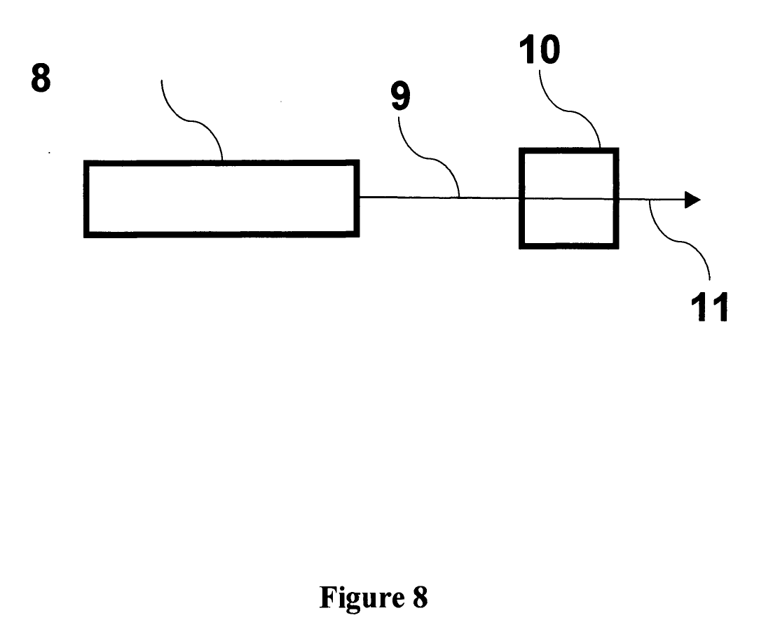

FIG. 8 shows a schematic for producing ˜406 nm laser radiation by second harmonic generation, or SHG, of fundamental laser radiation at a wavelength of ˜812 nm produced by a Tm:host laser emitting in the ³H₄-³H₆ transition. A diode-pumped Tm:host solid state laser, 8, produces an output beam, 9, at a nominal wavelength of ˜812 nm, that is passed through a nonlinear optical crystal, 10, that is oriented so as to phase-match the propagation of beams with wavelengths of ˜812 nm and ˜406 nm. An output beam, 11, at a wavelength of ˜406 nm is generated in the nonlinear optical crystal, 10, The nonlinear crystal may take the form of a bulk nonlinear optical crystal, such as LBO or BIBO that both can be oriented for phase-matched second harmonic generation at a fundamental wavelength of ˜812 nm, or it may take the form of a periodically-poled ferroelectric such as lithium tantalite (LiTaO₃) whose period is set to be SHG phase-matched at a fundamental wavelength of ˜812 nm.

A laser source emitting at a wavelength of ˜270 nm can be realized by sum-frequency-mixing (SFM) the ˜812 nm radiation and the ˜406 nm radiation of the thulium-based lasers of the present invention, according to SFM principles that are well known in the art. A laser source emitting at a wavelength of ˜203 nm can be realized by two means: 1) SFM the ˜812 nm radiation and the ˜270 nm radiation of the thulium-based lasers of the present invention, according to principles that are well known in the art; or 2) second harmonic generation of the ˜406 nm radiation of the thulium based laser of the present invention, according to principles well known in the art

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent to one skilled in the art, and all equivalent relationships to those illustrated in the drawings and described in the specification are intended to be encompassed by the present invention.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

I claim:

1. A solid state laser, comprising:
a laser cavity resonant at a first wavelength within a first range from about 800 nm to about 824 nm;
a dielectric crystal laser gain medium doped with trivalent thulium ions (Tm³⁺), wherein said dielectric crystal laser gain medium is operatively located within said laser cavity;
means for optically pumping said gain medium with light having a wavelength within a second range from about 760 nm to about 800 nm; and
means for suppressing laser action on a first thulium ion transition and a second thulium ion transition, wherein said first thulium ion transition has a center wavelength of about ˜1470 nm and wherein said second thulium ion transition has a center wavelength of about ˜2350 nm, to produce laser emission having a first laser emission wavelength within said first range.

2. The laser of claim 1, further comprising means for Q-switching said laser cavity.

3. The laser of claim 1, further comprising means for mode locking said laser cavity.

4. The laser of claim 1, further comprising means for frequency-doubling said first laser emission wavelength to produce light having a second laser emission wavelength within a second range from about 400 nm to about 412 nm.

5. The laser of claim 4, further comprising means for frequency-doubling said second laser emission wavelength to produce light having a third laser emission wavelength within a third range from about 200 nm to about 206 nm.

6. The laser of claim 4, further comprising means for sum-frequency-mixing said first laser emission wavelength with said second laser emission wavelength to produce light having a fourth laser emission wavelength within a fourth range from about 267 nm to about 275 nm.

7. The laser of claim 1, wherein said means for optically pumping said gain medium is configured to end pump said dielectric crystal laser gain medium.

8. The laser of claim 1, wherein said dielectric crystal laser gain medium is selected from the group consisting of LiYF₄, LiGdF₄, KY₃F₁₀, LiNaY₂F₈, BaY₂F₈, K₅Li₂GdF₁₀, K₅Li₂LaF₁₀, Y₃Al₅O₁₂ (YAG), and YAlO₃ (YAP).

9. The laser of claim 1, wherein said dielectric crystal laser gain medium comprises a cation substitutional variant of a compound selected from the group consisting of LiYF₄, LiGdF₄, KY₃F₁₀, LiNaY₂F₈, BaY₂F₈, K₅Li₂GdF₁₀, K₅Li₂LaF₁₀, Y₃Al₅O₁₂ (YAG), and YAlO₃ (YAP).

10. A method, comprising:
providing a laser cavity resonant at a first wavelength within a first range from about 800 nm to about 824 nm;
operatively locating a dielectric crystal laser gain medium within said laser cavity, wherein said dielectric crystal laser gain medium is doped with trivalent thulium ions (Tm³⁺);
optically pumping said gain medium with light having a wavelength within a second range from about 760 nm to about 800 nm; and
suppressing laser action on a first thulium ion transition and a second thulium ion transition, wherein said first thulium ion transition has a center wavelength of about ˜1470 nm and wherein said second thulium ion transition has a center wavelength of about ˜2350 nm, to produce laser emission having a first laser emission wavelength within said first range.

11. The method of claim 10, further comprising Q-switching said laser cavity.

12. The method of claim 10, further comprising mode locking said laser cavity.

13. The method of claim 1, further comprising frequency-doubling said first laser emission wavelength to produce light having a second laser emission wavelength within a second range from about 400 nm to about 412 nm.

14. The method of claim 14, further comprising frequency-doubling said second laser emission wavelength to produce light having a third laser emission wavelength within a third range from about 200 nm to about 206 nm.

15. The method of claim 14, further comprising sum-frequency-mixing said first laser emission wavelength with said second laser emission wavelength to produce light having a fourth laser emission wavelength within a fourth range from about 267 nm to about 275 nm.

16. The method of claim 10, wherein the step of optically pumping comprises end pumping said dielectric crystal laser gain medium.

17. The method of claim 10, wherein said dielectric crystal laser gain medium is selected from the group consisting of LiYF₄, LiGdF₄, KY₃F₁₀, LiNaY₂F₈, BaY₂F₈, K₅Li₂GdF₁₀, K₅Li₂LaF₁₀, Y₃Al₅O₁₂ (YAG), and YAlO₃ (YAP).

18. The method of claim 10, wherein said dielectric crystal laser gain medium comprises a cation substitutional variant of a compound selected from the group consisting of LiYF₄, LiGdF₄, KY₃F₁₀, LiNaY₂F₈, BaY₂F₈, K₅Li₂GdF₁₀, K₅Li₂LaF₁₀, Y₃Al₅O₁₂ (YAG), and YAlO₃ (YAP).
